(19) United States
(12) Patent Application Publication
(10) Pub. No.: US 2021/0251133 A1
(43) Pub. Date: Aug. 19, 2021

(54) DUAL-PLACEMENT FERTILIZER SYSTEM

(71) Applicant: ROSEDALE AG SERVICES, LLC, Montgomery, IN (US)

(72) Inventor: MICHAEL WAGLER, MONTGOMERY, IN (US)

(73) Assignee: ROSEDALE AG SERVICES, LLC, MONTGOMERY, IN (US)

(21) Appl. No.: 17/177,945

(22) Filed: Feb. 17, 2021

Related U.S. Application Data
(60) Provisional application No. 62/978,010, filed on Feb. 18, 2020.

(51) Int. Cl. A01C 23/02; A01C 23/00

(52) U.S. Cl. CPC A01C 23/025; A01C 23/008

(57) ABSTRACT

A dual-placement fertilizer system for applying fertilizer at the base of crops and attached to a single coulter fertilizer system is provided. The system includes mounting means for attaching to the single coulter fertilizer system. A pivot plate is pivotally connected to the mounting means. The pivotal connection may be accomplished through a cylindrical sleeve affixed to a trailing edge of the second section of the mounting bracket, and a pivot pin extending through the cylindrical sleeve and having a first end affixed to the pivot plate for permitting the pivot plate to oscillate relative to the mounting bracket. First and second fertilizer supply lines, each having a first end affixed to the pivot plate, extend outwardly from the pivot plate in substantially opposing direction relative to one another to a second open end for dispersing liquid fertilizer at the base of crops. Means for supplying liquid fertilizer from a fertilizer tank through the first and second fertilizer supply lines to the base of crops is also provided.

### BACKGROUND OF THE INVENTION

### Field of the Invention

The present invention relates to systems and devices for side dressing application of fertilizers or other liquid products to assist plant growth. More specifically, the present invention relates to a dual-placement fertilization attachment which can be mounted to a standard single Coulter injection system to allow both injection of fertilizer in the row center and next to the plant.

### Description of the Related Art

In modern farming practices, sidedressing applications of fertilizers or other liquid products to assist plant growth are a common practice. Sidedressing is when fertilizer, such as a solution of urea and ammonium nitrate in water (UAN), is applied between rows of young plants to provide a boost during periods of rapid growth and nutrient uptake. The two most common methods of side dressing include: (1) injection of UAN between crop rows with disc openers, and (2) application of UAN with a sprayer fitted with drip nozzles.

The first method of injecting between crop rows with disc openers, also known as the single-Coulter method, uses a heavy rotary disc mounted on a rotary hub with down pressure to ensure that the disc stays in the soil. The system injects fertilizer into the soil at the center of the row with an injection nozzle or a knife. The primary advantage of this system is the injection of fertilizer into the soil near the roots where it is needed most. However, since the fertilizer is injected in the middle of the row, it is not as close to the roots as it could be. Fro example, where 30″ rows are used, the fertilizer is injected 15″ from each row.

The second method of applying fertilizer with drip nozzles is shown in U.S. Pat. No. 9,167,745. A drop assembly coupled to the boom and extending downward. A base assembly is coupled to the lower end of the drop assembly and a hose assembly extends from the distribution hose to the base assembly. A lower hose assembly is protected within the base assembly and includes a pair of dribble hoses extruding from the base assembly. The liquid product is delivered proximate to the ground surface through the dribble hoses. An advantage of this method is application of the fertilizer closer to the plant. However, loss of effectiveness is more prevalent in surface applications such as this as the fertilizer is not applied below the surface near the roots.

One attempt to marry the best of both systems has been made by Unverferth Manufacturing Company in its Dual Delivery System, which features a single coulter disc equipped with an injection nozzle or knife coupled with coulter-mounted drop hoses on each side of the coulter. This option allows the operator flexibility in injecting fertilizer in the row center, and/or next to the plant for faster uptake. The U-shaped steel coulter-mounting bracket positions the tubes outward for application at the plant's base.

A disadvantage of the Unverferth Dual Delivery system is in the consistency of application at the plant base by the drop hoses. The hoses merely trail behind the coulter and do not have any means for ensuring that they remain near the plant base. In fact, inconsistencies in the earth surface and the plants themselves can, and often do push the hose away from the base of the plant resulting in less than optimal fertilization.

Accordingly, there is a need for a dual placement fertilizer attachment that can be used in conjunction with a standard Coulter injection fertilizer wherein the device includes mechanisms for ensuring the drip hoses remain close to the plant bases.

### SUMMARY OF THE INVENTION

It is therefore an object of the present invention to provide a device that can be quickly and easily mounted to a standard single Coulter fertilizer system to allow the operator to inject fertilizer in the row center and next to the plant for faster uptake.

It is also an object of the invention to provide a system where the drop hoses that apply fertilizer next to the plant are consistently positioned near the base of the plant to more effectively apply fertilizer where needed.

The present invention meets these objects by providing an attachment to a standard single Coulter fertilizer system with a pair of drop hoses that apply fertilizer near the plant in addition to the fertilize that is injected by the Coulter disc and injector nozzle. The present invention also provides a pivot mechanism that ensures the ends of the hoses where the fertilizer is ejected remain at or near the plants.

According to one presently preferred embodiment of the invention, there is provided a dual-placement fertilizer system for applying fertilizer at the base of crops and attached to a single coulter fertilizer system comprising mounting means for attaching to the single coulter fertilizer system; a pivot plate pivotally connected to said mounting means; first and second fertilizer supply lines each having a first end affixed to said pivot plate and extending outwardly from said pivot plate in substantially opposing direction relative to one another to a second open end for dispersing liquid fertilizer at the base of crops; and means for supplying liquid fertilizer from a fertilizer tank through the first and second fertilizer supply lines to the base of crops.

The mounting means may comprise a mounting bracket having a first section attached to said single coulter fertilizer system and a second section pivotally connected to said pivot plate. The mounting bracket may be L-shaped. The mounting bracket may be removably affixed to the single coulter fertilizer system.

The dual-placement fertilizer system may further include a cylindrical sleeve affixed to a trailing edge of said second section of the mounting bracket, and a pivot pin extending through said cylindrical sleeve and having a first end affixed to said pivot plate for permitting the pivot plate to oscillate relative to the mounting bracket.

The first and second fertilizer supply lines may each further comprise a first rigid supply line having a first end affixed to said pivot plate; and a flexible fertilizer supply line having a first end attached to and in fluid communication with a second end of said rigid fertilizer supply line, and a second open end for dispersing liquid fertilizer at the base of crops. The rigid supply lines may extend outwardly and downwardly from outer edges of the pivot plate.

The means for supplying liquid fertilizer may comprise one or more upper fertilizer supply lines in fluid communication with said first and second fertilizer supply lines and said fertilizer tank.There may also be provided a main upper supply line having a first end in fluid communication with said fertilizer tank; a y-connector having an inlet in fluid communication with said main upper supply line; and first and second upper supply lines, each having a first end in fluid communication with an outlet of said y-connector and a second end in fluid communication with one of said first and second fertilizer supply lines.

These and other objects, features and advantages of the present invention will become apparent from a review of the following drawings and detailed description of the preferred embodiments of the invention.

### BRIEF DESCRIPTION OF THE DRAWINGS

The present invention can best be understood in connection with the accompanying drawings. It is noted that the invention is not limited to the precise embodiments shown in the drawings, in which:

FIG. 1 is a side perspective view of a dual-placement fertilizer attachment according to a presently preferred embodiment of the invention shown attached to a single Coulter fertilizer system.

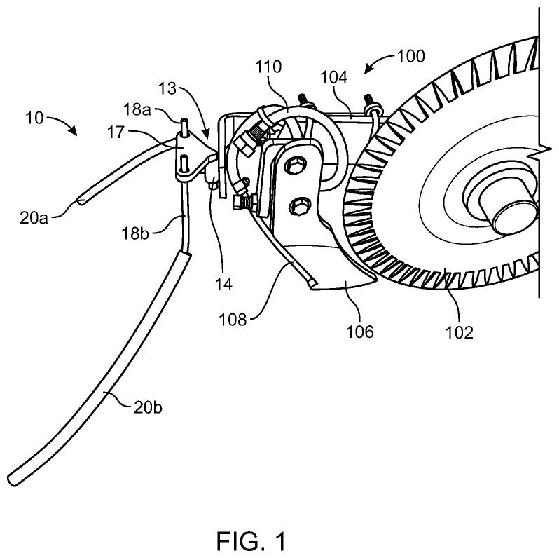

FIG. 2 is a front perspective view of the dual-placement fertilizer attachment and single Coulter fertilizer system shown in FIG. 1 with the arm assembly pivoted to the left side.

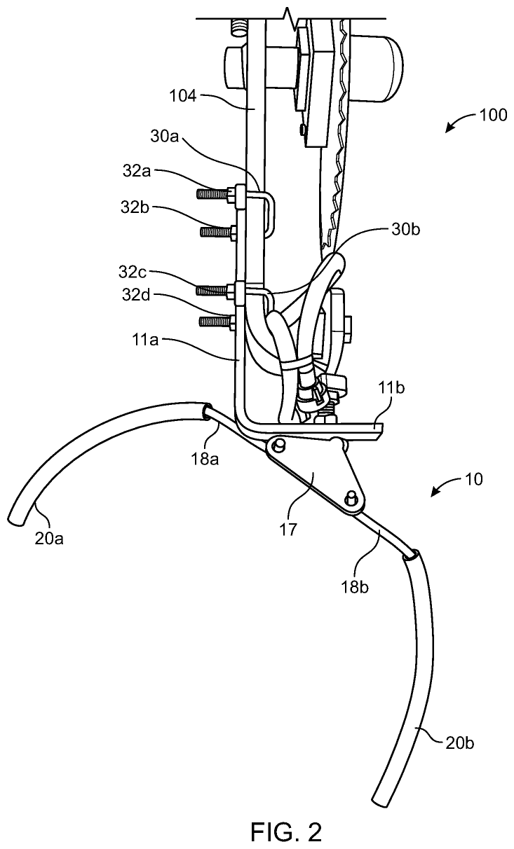

FIG. 3 is a front perspective view of the dual-placement fertilizer attachment and single Coulter fertilizer system shown in FIG. 1 with the arm assembly pivoted to the right side.

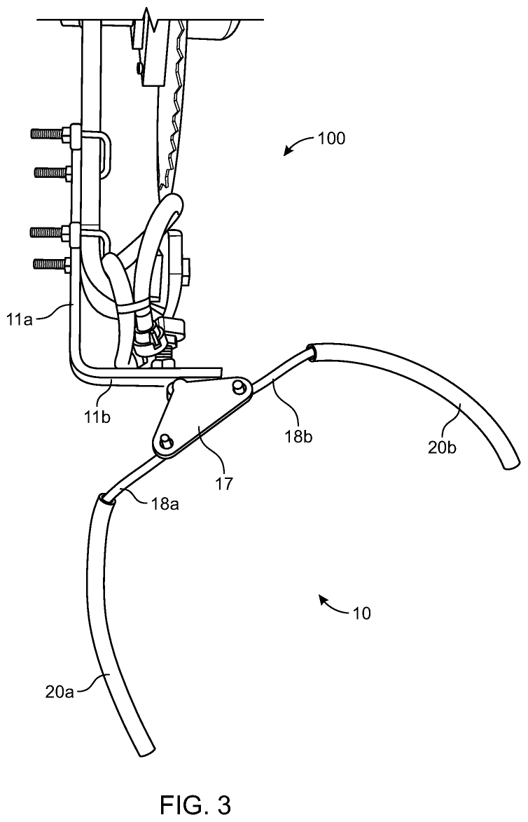

FIG. 4 is a front elevational view of the dual-placement fertilizer attachment shown in FIG. 1.

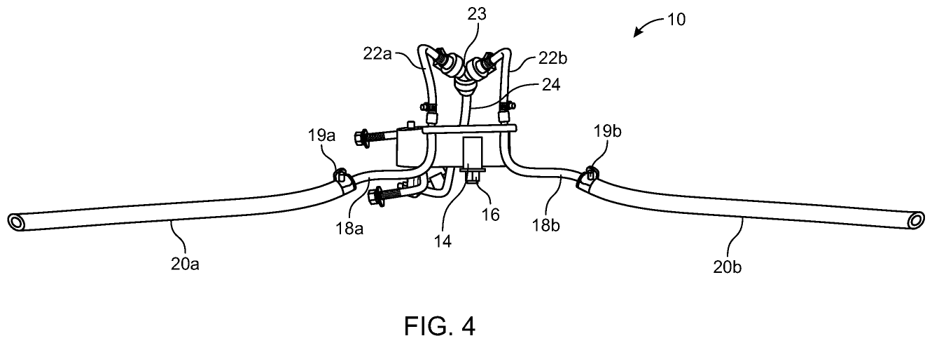

FIG. 5 is a side elevational view of the dual-placement fertilizer attachment shown in FIG. 4.

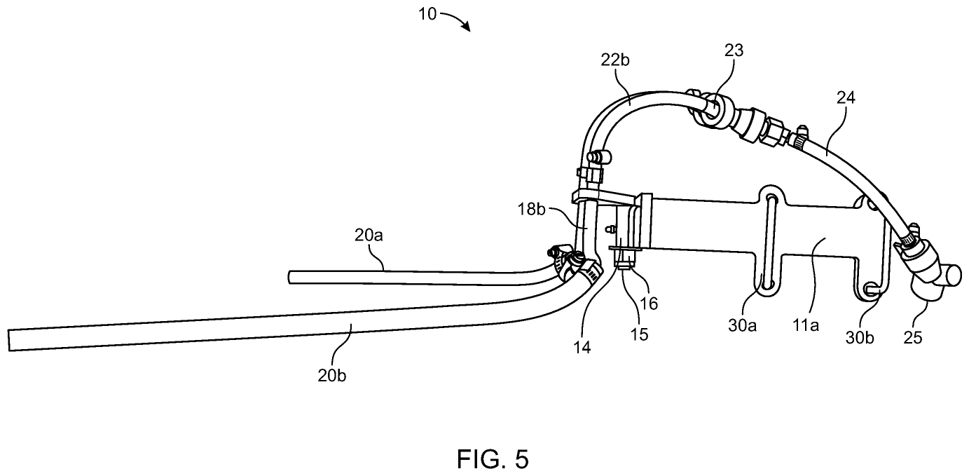

FIG. 6 is a top plan view of the dual-placement fertilizer attachment shown in FIG. 4 and FIG. 5.

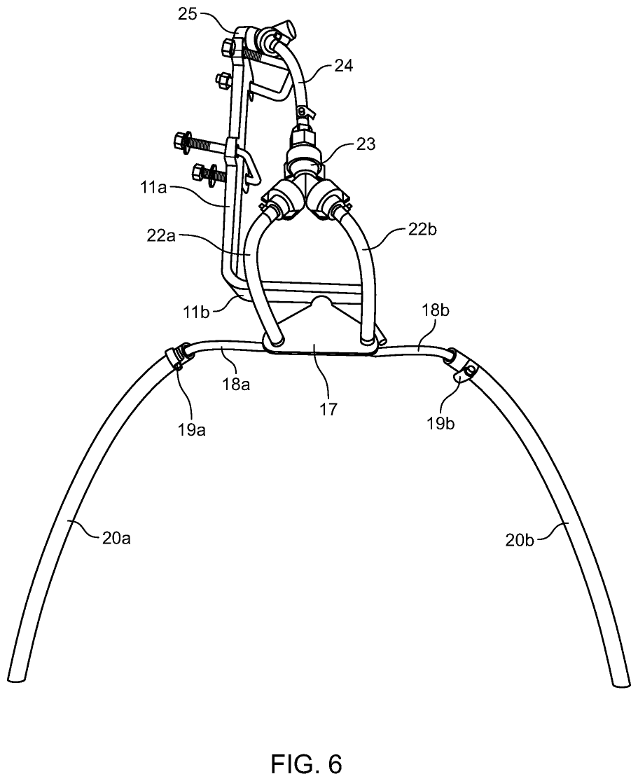

### DETAILED DESCRIPTION OF THE INVENTION

For purposes of promoting and understanding of the principles of the invention, reference will now be made to the embodiments illustrated in the drawings and specific language will be used to describe the same. It will nevertheless be understood that no limitation of the scope of the invention is thereby intended. The invention includes any alterations and further modifications in the illustrated devices and described methods and further applications of the principles of the invention that would normally occur to one skilled in the art to which the invention relates.

As best shown in the drawings, one presently preferred embodiment of the invention comprises a dual-placement fertilizer attachment 10 that is configured for attachment to a single coulter fertilizer system 100. The single coulter fertilizer system 100 includes a coulter disc 102 that is rotatably attached to the beam 104 of the fertilizer system 100, to make a vertical cut in the surface, and to permit clean separation and effective covering of the soil and materials being turned under. A fertilizer knife 106 is located behind the disc 102 and includes an injection nozzle 108 that is in fluid communication with a fertilizer tank (not shown) via supply tube 110. As the coulter disc 102 makes vertical cuts in the soil surface, the knife 106 and injector 108 supply liquid fertilizer to the soil beneath the surface.

The dual-placement fertilizer attachment 10 includes an L-shaped mounting bracket 11, the first leg 11a of which is removably attached to the beam 104 of the single coulter fertilizer system 100 by fastening means. In the embodiment shown in the drawings, the first leg 11a of the bracket 11 is provided with a plurality of openings 12a, 12b, 12c, 12d which are configured to receive u-bolts 30a, 30b which wrap around the beam 104 and pass through the openings 12a, 12b, 12c, 12d, respectively. Nuts 32a, 32b, 32c, 32d are secured to the threaded ends of the u-bolts 30a, 30b to secure the attachment 10 to the fertilizer system 10.

The second leg 11b of the bracket 11 extends substantially transversely behind the coulter disc 102 and knife 106. A pivot point 13 is located on the trailing edge of the second leg 11b and is substantially aligned with the coulter disc 102, knife 106 and injector 108. The pivot point 13 as shown in the drawings includes a cylindrical sleeve 104 affixed to the trailing edge of the second leg 11b. A pivot pin 15 passes through the sleeve 14 and is secured in place at a lower end by a nut 16. A pivot plate 17 is affixed to the upper end of the pivot pin 15.

Rigid supply lines 18a, 18b extend outwardly and downwardly from the outer edges of the pivot plate 17. The rigid supply lines 18a, 18b extend outwardly a total distance that is less than the distance between crop rows for which it is intended to apply fertilizer. Flexible terminal supply lines 20a, 20b are attached to the ends of the rigid supply lines 18a, 18b by fasteners such as hose clamps 20a, 20b. The free ends of the flexible terminal supply lines 20a, 20b are spaced a distance apart that approximates the distance between crop rows. The flexible terminal supply lines 20a, 20b may be formed from any flexible material such as rubber or rubberized material. According to one preferred embodiment, the flexible terminal supply lines are wire-braid-reinforced hydraulic type rubber hoses, namely ISO 1436-1/1SN/SAE 100R1 specification hoses.

Upper supply lines 22a, 22b supply liquid fertilizer from the fertilizer tank (not shown) to the first ends of the rigid supply lines 18a, 18b. To reduce redundant lengths of hose, a hose y-connector 23 merges the two upper supply lines 22a, 22b into a main supply line 24, which, in turn is merged with the coulter supply tube 110 at a second hose y-connector 25 such that a main supply line from the fertilizer tank (not shown) feeds both the coulter fertilizer system 100 and the dual-placement fertilizer attachment 10 via a main supply line that extends from the fertilizer tank to the second hose y-connector 25.

In operation, the single coulter fertilizer system 100 is attached to the boom of a device that extends laterally outward from a device pulled behind a tractor or other farming implement. multiple single coulter fertilizer systems are attached to the boom and aligned with the rows between crops so that each single coulter fertilizer system 100 is aligned in the middle of a row between crops. As the implement in pulled along the row, the coulter disc 102 makes a vertical cut in the surface to permit clean separation and effective covering of the soil and materials being turned under. The fertilizer knife 106 and associated injector 108 inject fertilizer in beneath the surface in the middle of the row.

At the same time, or separately if desired, fertilizer can be applied at the base of the crops by flexible terminal supply lines 20a, 20b. As the implement is pulled along the crop row, the ends of the flexible terminal supply lines 20a, 20b drag along the ground in the area at the base of the crop rows. If one of the terminal supply lines encounters an obstacle, such as a rock, it may be knocked off alignment. The pivot point 13 allows the assembly to pivot back and forth to adjust for such abnormalities and return the end of the terminal supply line to the appropriate position after the obstacle is passed.

This detailed description, and particularly the specific details of the exemplary embodiment disclosed, is given primarily for clearness of understanding and no unnecessary limitations are to be understood therefrom, for modifications will become evident to those skilled in the art upon reading this disclosure and may be made without departing from the spirit or scope of the claimed invention.

I claim:

1. A dual-placement fertilizer system for applying fertilizer at the base of crops and attached to a single coulter fertilizer system comprising:
mounting means for attaching to the single coulter fertilizer system;
a pivot plate pivotally connected to said mounting means;
first and second fertilizer supply lines each having a first end affixed to said pivot plate and extending outwardly from said pivot plate in substantially opposing direction relative to one another to a second open end for dispersing liquid fertilizer at the base of crops; and
means for supplying liquid fertilizer from a fertilizer tank through the first and second fertilizer supply lines to the base of crops.

2. The dual-placement fertilizer system according to claim 1, wherein said mounting means comprises a mounting bracket having a first section attached to said single coulter fertilizer system and a second section pivotally connected to said pivot plate.

3. The dual-placement fertilizer system according to claim 2, wherein said mounting bracket is L-shaped.

4. The dual-placement fertilizer system according to claim 2, wherein said mounting bracket is removably affixed to said single coulter fertilizer system.

5. The dual-placement fertilizer system according to claim 2, further comprising:
1. a cylindrical sleeve affixed to a trailing edge of said second section of the mounting bracket, and
2. a pivot pin extending through said cylindrical sleeve and having a first end affixed to said pivot plate for permitting the pivot plate to oscillate relative to the mounting bracket.

6. The dual placement fertilizer system according to claim 1, wherein said first and second fertilizer supply lines each further comprise:
a first rigid supply line having a first end affixed to said pivot plate; and
a flexible fertilizer supply line having a first end attached to and in fluid communication with a second end of said rigid fertilizer supply line, and a second open end for dispersing liquid fertilizer at the base of crops.

7. The dual-placement fertilizer system according to claim 6, wherein said rigid supply lines extend outwardly and downwardly from outer edges of the pivot plate.

8. The dual-placement fertilizer system according to claim 1, wherein the means for supplying liquid fertilizer comprises one or more upper fertilizer supply lines in fluid communication with said first and second fertilizer supply lines and said fertilizer tank.

9. The dual-placement fertilizer system according to claim 8, further comprising:
a main upper supply line having a first end in fluid communication with said fertilizer tank;
a y-connector having an inlet in fluid communication with said main upper supply line; and
first and second upper supply lines, each having a first end in fluid communication with an outlet of said y-connector and a second end in fluid communication with one of said first and second fertilizer supply lines.
